(19) United States
(12) Patent Application Publication
(10) Pub. No.: US 2005/0110944 A1
(43) Pub. Date: May 26, 2005

(54) Method and apparatus for viewing a golf putting green

(76) Inventor: Charles E. Pfund, W. Newton, MA (US)

Correspondence Address: Charles E. Pfund, 165 Highland Street, W. Newton, MA, 02465, US

(21) Appl. No.: 10/717,874

(22) Filed: Nov. 20, 2003

(51) Int. Cl. G02C 7/12

(52) U.S. Cl. 351/49

(57) ABSTRACT

This invention provides binocular eyeglasses that have linear polarizing lenses to be employed by a golfer to examine the surface of a putting green as an aid in deciding the speed and direction for a putting stroke. The planes of maximum transmission for the lenses are preferably complementary 45° to horizontal. A modified use and a modified embodiment provide for alternate angles of inclination relative to horizontal.

### FIELD OF THE INVENTION

This invention relates to an aid for viewing a golf putting green to assist in discerning the subtle variations in the putting surface.

### BACKGROUND OF THE INVENTION

The game of golf consists of two almost completely independent phases of play for each hole, the first being one or more powerful strokes to advance the ball from the teeing ground to a position on the putting green. The second phase consists of one or more carefully directed light strokes to advance the ball by rolling it into the cup.

Since the game of golf is centuries old and enjoys immense popularity around the world the attention that has been given to each phase of the game is enormous. The design and layout of the course itself, the multitude of club designs for each phase of play, the ball, and the putting green all have been exhaustively treated in both the literature and actual embodiments. The putting green alone remains an enigma that consumes more care and attention per square foot than any other part of the course and more time by the players scrutinizing the surface of the green before deciding on the line and speed for stroking a putt.

### BRIEF SUMMARY OF THE INVENTION

The present invention provides for viewing the surface of a putting green to reveal more detail of the putting surface than can ordinarily be seen by the unaided human eye.

As previously mentioned, the putting green surface is essentially unique in the practice of agrology. This preparation is followed by contouring the surface and almost daily attention to the vitality of the grass surface to keep it growing under extremely close mowings. This procedure results in the putting surface that is presented to and closely studied by the serious golfer in preparation for stroking a putt.

The present invention uses linear polarizing lenses to reveal to the player during the normal course of play a unique view of the putting surface in the nature of a mosaic which can supplement the golfer's normal view as an aid in deciding the direction and speed for the putting stroke. The lenses are preferably clear or only slightly tinted to assure the maximum flux to the retina.

### BRIEF DESCRIPTION OF THE DRAWINGS

FIG. 1 is a rudimentary sketch of the principle components of human vision: eyes, optic nerves and brain.

FIG. 2 is a view of an ordinary frame for eyeglasses the lenses of which are linearly polarized with the planes of maximum transmission oriented at complementary 45° angles.

FIG. 3 is a schematic view of a frame such as found in a pair of ordinary clip-on type sunglasses, but with the lenses having 45° complementary linear polarization and being supported on a horizontal pivot axis to permit the lenses to be rotated out of the line of vision of the supporting eyeglasses.

FIGS. 4A and 4B are diagrams illustrating the ability to sweep the linear polarization reception angles between approximately zero and ninety degrees.

FIG. 5 is a partial view of a pair of glasses having linear polarizing lenses rotatable in the frame.

FIG. 6 is a sectional view on the line 6-6, of FIG. 5 illustrating the circular lens mounted in a circumfrential groove for rotatable support.

### DETAILED DESCRIPTION OF THE INVENTION

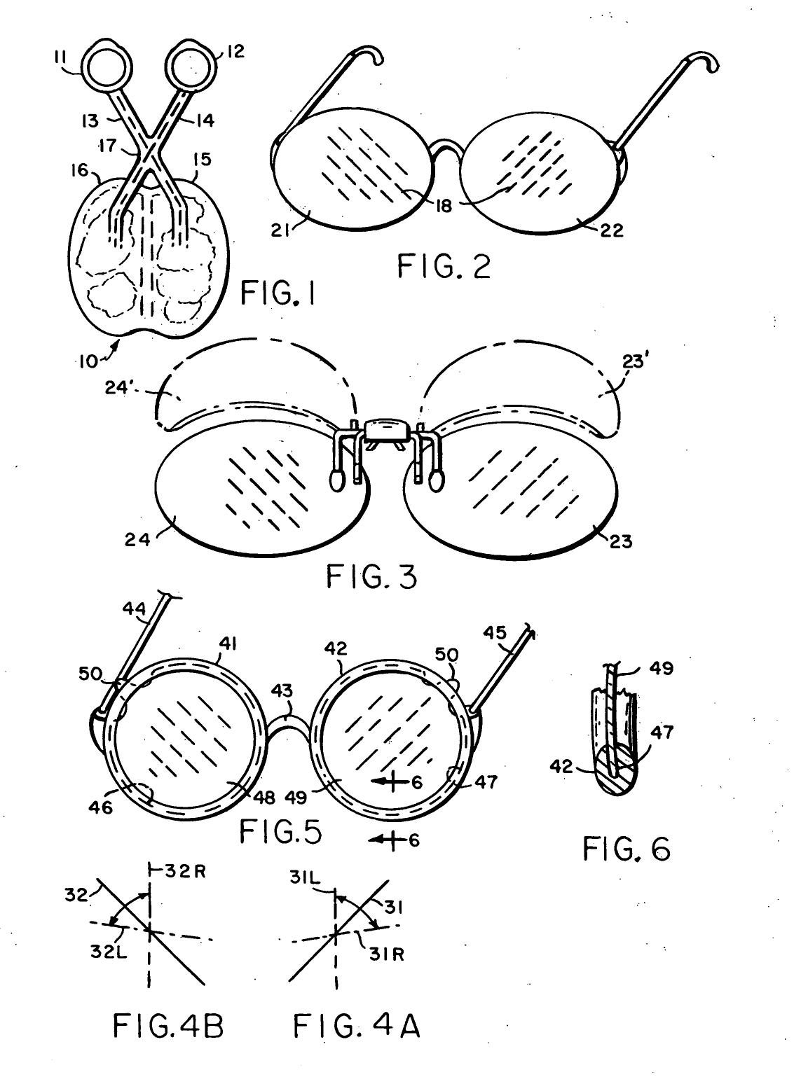

FIG. 1 is a rudimentary sketch of the human eye-brain visual complex. A left eye 11 and a right eye 12 form the visual image stumuli on the respective retinas that are conveyed by optic nerves of each eye to the brain 10. As shown, an optic nerve 13 carries these signals from the left eye 11 to a right half 15 of the brain 10 while an optic nerve 14 carries the signals from the right eye 12 to a left half 16 of the brain 10. The crossover of these nerve signals occurs in an optic chiasm 17.

None of this eye-brain physiology is apparent to an individual with normal eyesight but it provides the essential capability for such an individual to perceive the reality he observes by erecting a coherrent view from the distinct left and right eye signal sources. In other words the human eye-brain system can process signals representing different images into a unified whole.

FIG. 2 shows an ordinary eyeglass frame in which are mounted linear polarizer lenses 21, 22 oriented with the axes of maximum transmission at complementary 45° angles. The lenses 21, 22 can be ordinary linear polarizing material or ground corrective lenses which incorporate this feature. The phantom lines 18 are not visible but merely indicate the plane of orientation of the axes of maximum transmission. With these axes oriented at complementary angle planes the resultant image perceived by the wearer would be the brain's resultant vector sum of the polarized light images transmitted through lenses 21, 22.

Throughout this specification and claims “lenses” means any optical element that modifies the transmitted light such as linear polarization, corrective refraction, attenuation (i.e. sunglasses) or a combination of either or both of the latter with linear polarization.

FIG. 3 shows a conventional clip-on type frame, as used in sunglasses, to provide easy temporary attachment to a pair of eyeglasses for a pair of linear polarizer lenses 23 and 24 oriented as indicated at complementary 45° angles of maximum transmission. As is common in sunglasses frames the lenses 23 and 24 can be tipped upward, as indicated at 23′, 24′ in FIG. 3 out of the line of vision of the supporting eyeglasses. This type of frame, in addition to being convenient to use, also permits the golfer to scrutinize the putting surface conveniently with and without the polarized image thereby aiding his decision on his putting stroke.

FIGS. 4A and 4B taken together illustrate a technique the golfer can use to sweep the linear polarization orientation over the field of view. Consider the wearer is looking through the lenses of FIG. 3 with the preferred 45° orientation as described for FIG. 3, that is, looking into and through the plane of the paper. The plane of polarization of lens 23 in FIG. 3 is indicated in FIG. 4A by the 45° inclination of line 31. Similarly the plane of polarization of lens 24 in FIG. 3 is indicated in FIG. 4B by the 45° inclination of line 32.

Now while viewing the putting surface with the glasses of FIG. 3 the golfer by standing erect and tilting his head from side to side can see variations in the putting surface as viewed through complementary angled lenses rotated through a range approaching vertical-horizontal and horizontal-vertical. Thus with a left-tilt of the golfer's head the polarization plane 32 in FIG. 4B approaches horizontal represented as 32L while the polarization plane 31 in FIG. 4A approaches vertical represented as 31L.

The sweep is reversed for a right-tilt of the golfer's head with the plane 31 in FIG. 4A approaching horizontal represented as 31R while the plane 32 in FIG. 4B approaches vertical represented as 32R.

Referring to FIG. 5 a modified form of eyeglasses is shown. Two circular rims 41, 42 are assembled as usual connected by a nose bridge 43 and temple ear pieces 44, 45. The rims 41, 42 each have an inner peripheral groove 46, 47 in which circular linear polarizer lense 48, 49 are retained but freely rotatable using tabs 50 which project from the lenses 48, 49 beyond the rims 41, 42. A partial detail of the sliding rotation mounting of lens 49 in groove 47 of rim 42 is shown in section in FIG. 6. The modification shown in FIG. 5 and FIG. 6 permits the golfer to select the angle of maximum transmission of lenses 48, 49 between horizontal and vertical if, in use, an angle other than 45° is preferred.

1-9. (canceled)

10. A pair of eyeglasses having a clip-on bracket for convenient attachment to a standard pair of eyeglasses which has, when worn, a binocular line of vision comprising:
a pair of linear polarizer lenses each having a plane of maximum light transmission;
means for mounting said lenses on said bracket which when worn on said standard pair of eyeglasses orients said maximum planes of transmission at approximately 45° above horizontal and approximately complementary;
said bracket having means adapted to permit said polarizer lenses to be manually tipped in and out of said line of vision.

11. A pair of eyeglasses with suitable structure to support a pair of linear polarizer lenses, each lens having a plane of maximum light transmission and comprising:
on said eyeglasses means for mounting said lenses to establish a binocular line of vision for the wearer through said lenses;
said lenses when worn having said planes of maximum light transmission approximately 45° above horizontal and approximately complementary; and
said means for mounting said lenses having a horizontal pivot axis member supporting said lenses and adapted for manual tilting of the mounted lenses in and out of said line of vision of the wearer.
